(19) United States
(12) Patent Application Publication
(10) Pub. No.: US 2025/0201487 A1
(43) Pub. Date: Jun. 19, 2025

(54) ELECTROLYTIC CAPACITOR SEPARATOR MANUFACTURING METHOD, ELECTROLYTIC CAPACITOR MANUFACTURING METHOD, ELECTROLYTIC CAPACITOR SEPARATOR, AND ELECTROLYTIC CAPACITOR

(71) Applicant: Panasonic Intellectual Property Management Co., Ltd., Osaka (JP)

(72) Inventors: Tatsuji AOYAMA, KYOTO FU (JP); Shumpei MATSUSHITA, YAMAGUCHI KEN (JP); Tomoyuki TASHIRO, YAMAGUCHI KEN (JP)

(21) Appl. No.: 18/849,758

(22) PCT Filed: Mar. 24, 2023
(86) PCT No.: PCT/JP2023/011922

§ 371 Date: Sep. 23, 2024

(30) Foreign Application Priority Data
Mar. 25, 2022 (JP) 2022-050323

(51) Int. Cl. H01G 9/02; H01G 9/00; H01G 9/145; H01G 9/15

(52) U.S. Cl. CPC H01G 9/02; H01G 9/0029; H01G 9/145; H01G 9/15

(57) ABSTRACT

A method of manufacturing a separator for an electrolytic capacitor includes a first step of attaching a conductive polymer component to a fiber sheet to obtain a composite sheet, and a second step of compressing the composite sheet to obtain a separator. The density of the composite sheet before compression is less than 0.60 g/cm³.

### TECHNICAL FIELD

The present disclosure relates to a method of manufacturing a separator for an electrolytic capacitor, a method of manufacturing an electrolytic capacitor, a separator for an electrolytic capacitor, and an electrolytic capacitor.

### BACKGROUND ART

Capacitors used in electronic devices are required to have a large capacity and small equivalent series resistance (ESR) in a high frequency range. As capacitors with a large capacity and low ESR, there are promising electrolytic capacitors that use a conductive polymer such as polypyrrole, polythiophene, polyfuran, or polyaniline, as a solid electrolyte.

PTL 1 (WO 2020/158783) proposes a method of manufacturing an electrolytic capacitor, the method including: a step of preparing an anode foil having a dielectric layer, a cathode foil, and a fiber structure; a step of preparing a conductive polymer dispersion liquid that contains a conductive polymer component and a dispersion medium; a step of applying the conductive polymer dispersion liquid to the fiber structure and then removing at least a portion of the dispersion medium to fabricate a separator; and a step of laminating the anode foil, the separator, and the cathode foil in sequence to fabricate a capacitor element, wherein the dispersion medium contains water, the fiber structure contains synthetic fibers in an amount of 50 mass % or more, and the density of the fiber structure is 0.2 g/cm³ or more and less than 0.45 g/cm³.

### CITATION LIST

### Patent Literature

PTL 1: WO 2020/158783

### SUMMARY OF INVENTION

### Technical Problem

If a high-density fiber structure is used to improve short-circuit resistance, particles of the conductive polymer component are unlikely to penetrate into the inside of the fiber structure when the conductive polymer dispersion liquid is applied to the fiber structure, because the gaps between the fibers of the fiber structure are small. This decreases the amount of the conductive polymer component attached to the inside of the fiber structure, resulting in an increase in ESR. As described above, it is difficult to improve short-circuit resistance and reduce ESR simultaneously.

### Solution to Problem

An aspect of the present disclosure relates to a method of manufacturing a separator for an electrolytic capacitor, the method including a first step of attaching a conductive polymer component to a fiber sheet to obtain a composite sheet and a second step of compressing the composite sheet to obtain a separator, wherein the density of the composite sheet before compression is less than 0.60 g/cm³.

Another aspect of the present disclosure relates to a method of manufacturing an electrolytic capacitor, the method including a step of preparing an anode foil, a step of preparing a cathode foil, a step of obtaining a separator by the above-described method of manufacturing a separator for an electrolytic capacitor, and a step of laminating the anode foil and the cathode foil with the separator interposed between the anode foil and the cathode foil.

Yet another aspect of the present disclosure relates to a separator for an electrolytic capacitor, including a composite sheet that includes a fiber sheet and a conductive polymer component attached to the fiber sheet, wherein the composite sheet has a density of 0.33 g/cm³ or more and less than 0.74 g/cm³, an air permeability of 0.5 sec/100 mL or more and less than 58 sec/100 mL, and a basis weight of 19.0×10⁻⁴ g/cm² or more.

Yet another aspect of the present disclosure relates to an electrolytic capacitor including an anode foil, a cathode foil, and a separator interposed between the anode foil and the cathode foil, wherein the separator is the above-described separator for an electrolytic capacitor.

### Advantageous Effects of Invention

According to the present disclosure, it is possible to obtain an electrolytic capacitor having excellent short-circuit resistance and low ESR.

Novel features of the present invention are set forth in the appended claims, but the present invention, both in terms of configuration and content, together with other objects and features of the present invention, will be better understood from the following detailed description taken in conjunction with the drawings.

### BRIEF DESCRIPTION OF DRAWINGS

FIG. 1A schematic cross-sectional view of an electrolytic capacitor according to an embodiment of the present disclosure.

FIG. 2A perspective view of a wound body in a partially unwound state.

### DESCRIPTION OF EMBODIMENTS

Hereinafter, embodiments according to the present disclosure will be described taking examples, but the present disclosure is not limited to the examples described below. In the following description, specific numerical values and materials will be exemplified, but other numerical values and other materials may be applied as long as the advantageous effects of the present disclosure can be obtained. The description “numerical value A to numerical value B” herein includes both numerical value A and numerical value B, and can be read as “numerical value A or more and numerical value B or less”. In the following description, when lower limits and upper limits of numerical values related to specific physical properties or conditions are exemplified, any of the exemplified lower limits and any of the exemplified upper limits can be combined as desired, as long as the lower limit is not equal to or greater than the upper limit. If a plurality of materials are exemplified, one of them may be selected and used alone, or two or more of them may be used in combination.

### [Method of Manufacturing Separator for Electrolytic Capacitor]

A method of manufacturing a separator for an electrolytic capacitor according to an embodiment of the present disclosure includes a first step of attaching a first conductive polymer component (hereinafter, also referred to as first polymer component) to a fiber sheet to obtain a composite sheet, and a second step of compressing the composite sheet to obtain a separator. The density of the composite sheet before compression is less than 0.60 g/cm³.

In the first step, a low-density fiber sheet is used so that the first polymer component can be attached to the inside of the fiber sheet. That is, the first polymer component can be placed on the outer surface of the fiber sheet and can also be sufficiently placed in the gaps between the fibers inside the fiber sheet. In addition, since the composite sheet is compressed in the second step, it is possible to obtain a separator with a small thickness and ensure that the first polymer component is firmly attached to the fibers. When a long separator is wound onto a roll, it is easy to maintain the state where the first polymer component is attached to the fibers. Therefore, the equivalent series resistance (ESR) of the electrolytic capacitor can be reduced.

The density of the composite sheet before compression is less than 0.60 g/cm³, and may be 0.59 g/cm³ or less, or may be 0.22 g/cm³ or more (or 0.25 g/cm³ or more) and less than 0.60 g/cm³ (or 0.59 g/cm³ or less). If the density of the composite sheet before compression is 0.60 g/cm³ or more, the density of the fiber sheet is high, and the first polymer component cannot be sufficiently attached to the inside of the fiber sheet, which may result in an increase in ESR.

The density of the composite sheet can be determined by the method described below.

A test piece of a predetermined size is cut out from the composite sheet, and dried at 125° C. for three hours or more to thoroughly remove any residual first dispersion medium from the test piece. Then, the length, width, thickness, and weight of the test piece are measured, and the weight is divided by the volume, calculated from the length, width, and thickness, to determine the density of the composite sheet. Five test pieces are taken, the densities of the five test pieces are determined, and the average value is calculated.

In the second step, the composite sheet is compressed to increase the density of the composite sheet, that is, the density of the fiber sheet. This improves the short-circuit resistance of the electrolytic capacitor and reduces leakage current.

Consequently, it is possible to achieve both lower ESR and improved short-circuit resistance of the electrolytic capacitor.

### (First Step)

From the viewpoint of ensuring the impregnation of the fiber sheet with the first polymer component, the density of the fiber sheet before compression used in the first step may be 0.58 g/cm³ or less (or 0.55 g/cm³ or less), or may be 0.20 g/cm³ or more and 0.58 g/cm³ or less (or 0.55 g/cm³ or less).

The density of the fiber sheet is determined in accordance with JIS C 2300-2 (Cellulosic papers for electrical purposes—Part 2: Methods of test). Specifically, a test piece of a predetermined size is cut out from the fiber sheet, dried at 105° C. for three hours or more, and then its density is determined by a gravimetric method. That is, the length, width, thickness, and weight of the test piece are measured, and the weight is divided by the volume, calculated from the length, width, and thickness, to determine the density of the fiber sheet. Five test pieces are taken, the densities of the five test pieces are determined, and the average value is calculated.

The first step includes, for example, a step 1a of preparing a conductive polymer dispersion liquid (hereinafter, also referred to as first polymer dispersion liquid) containing a first polymer component and a first dispersion medium, and a step 1b of applying the first polymer dispersion liquid to a fiber sheet, or impregnating the fiber sheet with the first polymer dispersion liquid, and then removing at least a portion of the dispersion medium. The first dispersion medium usually contains water. At least a portion of the first dispersion medium is removed by a drying process.

The fiber sheet is typically a fiber sheet containing cellulose fibers. Cellulose fibers are advantageous in terms of cost and electrolyte retention. Since cellulose fibers have hydroxyl groups, the fiber sheet containing cellulose fibers is likely to swell in the first dispersion medium containing water, and the swollen fiber sheet is likely to shrink during the drying process performed thereafter. In the first step, wrinkles may occur in the fiber sheet due to the swelling and shrinkage of the fiber sheet, but the irregularities in the sheet caused by the wrinkles can be reduced by compressing the composite sheet in the second step. This suppresses unevenness in the thickness of the separator due to the irregularities, and suppresses increases in the variation in the inter-electrode distance in the electrolytic capacitor due to the unevenness in the thickness.

In the step 1b, the first polymer component is attached to the surfaces of the fibers constituting the fiber sheet. In the step 1b, the first polymer component can be sufficiently attached to the inside of the fiber sheet by using a low-density fiber sheet. That is, the first polymer dispersion liquid smoothly penetrates into the inside of the fiber sheet, and the particles of the first polymer component can smoothly enter the gaps between the fibers.

The application of the first polymer dispersion liquid to the fiber sheet in the step 1b may be performed by a coating method or a spraying method. Examples of a coater include known devices such as a gravure coater, a knife coater, a comma coater, a roll coater, a die coater, and a lip coater.

The coating process may be performed on one or both sides of the fiber sheet. The coating process may be performed a plurality of times on the same side of the fiber sheet. In this case, the drying process may be performed after the plurality of consecutive iterations of the coating process are performed, or after each iteration of the coating process is performed.

In the step 1b, the fiber sheet may be impregnated with the first polymer dispersion liquid by immersing the fiber sheet in the first polymer dispersion liquid contained in a container. The immersion process may be performed a plurality of times. The drying process may be performed after the plurality of consecutive iterations of the immersion process are performed, or after each iteration of the immersion process is performed.

The removal of the first dispersion medium in the step 1b is performed by the drying process. The drying process may be carried out by heating and drying at 50° C. or higher and 150° C. or lower, for example, or may be carried out under reduced pressure (for example, an atmosphere with a gauge pressure between −50 kPa and −90 kPa inclusive). At this time, the drying process may be performed to an extent that the first dispersion medium is not completely removed. However, it is desirable to carry out the drying process so as to remove 80% by mass or more (or 90% by mass or more) of the first dispersion medium from the first polymer dispersion liquid immediately after the application (impregnation), for example. In this case, in the second step (compression step), it is possible to suppress the attachment of the first polymer component contained in the composite sheet to a compression device (such as a mill roll), and suppress unevenness in the amount of the first polymer component attached to the composite sheet caused by the first polymer component attaching to the compression device.

The step 1b is preferably performed on an elongated fiber sheet. In this case, a roll-to-roll method can be adopted to enhance productivity. The step 1b can be performed by coating one side of the elongated fiber sheet, drying the coated side, and then winding the fiber sheet onto a roll, for example. Furthermore, the fiber sheet may then be unwound in a reversed state from the roll and the other side may be coated by the same or a different coater.

In impregnating the elongated fiber sheet with the first polymer dispersion liquid, a container containing the first polymer dispersion liquid is prepared, the elongated fiber sheet is conveyed into the container by a conveyance roll and immersed in the first polymer dispersion liquid, the fiber sheet is then conveyed out of the container and dried, and the resulting composite sheet is wound onto a roll.

### (Second Step)

In the second step, the composite sheet is compressed in the thickness direction to obtain a separator. In the second step, it is preferable to roll and press the composite sheet. A roll-to-roll method can be adopted for the elongated composite sheet to enhance productivity.

Ratio T1/T0 of a thickness T1 of the composite sheet (separator) after compression to a thickness T0 of the composite sheet before compression is preferably 0.50 or more and 0.95 or less, more preferably 0.60 or more and 0.95 or less. When T1/T0 is 0.95 or less, the effect of improving short-circuit resistance can be easily obtained due to the densification of the fiber sheet. When T1/T0 is 0.50 or more (or 0.60 or more), in the second step, the pressing pressure can be easily controlled to be appropriately small, so that the attachment of the first polymer component contained in the composite sheet to the pressing device (such as a mill roller) is suppressed, and the reduction and variation in the amount of the first polymer component contained in the composite sheet due to this attachment are suppressed. In this case, the composite sheet can be sufficiently impregnated with the electrolyte solution in the subsequent electrolyte solution impregnation step.

From the viewpoints of reducing the ESR and improving the short-circuit resistance, the thickness T1 of the composite sheet (separator) after compression may be 20 μm or more and 90 μm or less, for example, and may be 25 μm or more and less than 60 μm (or 58 μm or less). The thickness T0 and thickness T1 of the composite sheet are the average values of thicknesses at any 10 points of the composite sheet before and after compression.

The composite sheet may be compressed while being heated and/or humidified. This allows the first polymer component to be more firmly attached to the fiber sheet, and reduces irregularities in the fiber sheet due to wrinkles. In this case, it is desirable to adjust the degree of heating and/or humidification within a range that suppresses the attachment of the first polymer component contained in the composite sheet to a pressing device (such as a mill roller).

The fiber sheet and the first polymer dispersion liquid used in the first step will be described in detail below.

### (Fiber Sheet)

The fiber sheet is a porous sheet made of a fiber material. The fiber sheet may be a woven fabric or a nonwoven fabric. The fiber sheet preferably contains at least cellulose fibers. The content of cellulose fibers in the fiber sheet is preferably 20% by mass or more, and may be 20% by mass or more and 80% by mass or less. This allows the composite sheet to be easily compressed.

The fiber sheet may contain cellulose fibers and synthetic fibers, or may be a mixture of cellulose fibers and synthetic fibers. In this case, the strength of the fiber sheet can be easily ensured, and the fiber sheet is less likely to swell with water. Examples of the synthetic fibers include nylon fibers, aramid fibers, acrylic fibers, polyester fibers, and polyphenylene sulfide fibers. One type of synthetic fiber may be used alone, or two or more types may be used in combination. The content of synthetic fibers in the fiber sheet is 20% by mass or more and 80% by mass or less, for example.

The fiber sheet may contain a paper strengthening agent together with the cellulose fibers. The paper strengthening agent may contain a wet paper strengthening agent and/or a dry paper strengthening agent. Examples of the wet paper strengthening agent include urea formaldehyde resin, melamine formaldehyde resin, polyamide polyamine epichlorohydrin, polyvinylamine, and the like. Examples of the dry paper strengthening agent include polyacrylamide, polyvinyl alcohol, starch, carboxymethyl cellulose, and the like. One type of paper strengthening agent may be used alone, or two or more types may be used in combination.

The thickness of the fiber sheet used in the first step is not particularly limited. The thickness of the fiber sheet before compression may be 25 μm or more and 100 μm or less, or may be 30 μm or more and 95 μm or less, for example. In this case, in the second step, the thickness of the separator (compressed fiber sheet) can be easily adjusted to a desired range from the viewpoints of improving the short-circuit resistance and reducing the ESR.

### (First Polymer Dispersion Liquid)

The first polymer dispersion liquid includes a first polymer component and a first dispersion liquid. The first polymer dispersion liquid can be obtained, for example, by dispersing particles of the first polymer component in a first dispersion medium, or by polymerizing a precursor monomer of the first polymer component in the first dispersion medium to generate particles of the first polymer component in the first dispersion medium.

The content of the first polymer component in the first polymer dispersion liquid may be 1 mass % or more (or 3 mass % or more) and 15 mass % or less, for example. When the content of the first polymer component is in the above range, a sufficient amount of the first polymer component can be attached to the fiber sheet.

The viscosity of the first polymer dispersion liquid may be 10 mPa·s or more (or 100 mPa·s or more) and 200 mPa·s or less, for example. In this case, the first polymer dispersion liquid can be easily applied to the fiber sheet, and the fiber sheet can be easily impregnated with the first polymer dispersion liquid. The viscosity of the polymer dispersion liquid is measured at room temperature (20° C.) using a vibration viscometer (for example, VM-100A manufactured by Sekonic Corporation).

### (First Polymer Component)

The first polymer component includes a conductive polymer. Examples of the conductive polymer include polypyrrole, polythiophene, polyfuran, polyaniline, and the like. One type of a conductive polymer may be used alone, or two or more types may be used in combination, or a copolymer of two or more types of monomers may be used.

Polypyrrole, polythiophene, polyfuran, polyaniline, and the like herein refer to polymers having polypyrrole, polythiophene, polyfuran, polyaniline, and the like as a basic skeleton, respectively. Therefore, polypyrrole, polythiophene, polyfuran, polyaniline, and the like may also include their respective derivatives. For example, polythiophene includes poly(3,4-ethylenedioxythiophene) and the like.

The first polymer component may further include a dopant. The dopant may be a polyanion. Specific examples of the polyanion include polyvinyl sulfonic acid, polystyrene sulfonic acid, polyallyl sulfonic acid, polyacryl sulfonic acid, polymethacryl sulfonic acid, poly(2-acrylamido-2-methylpropane sulfonic acid), polyisoprene sulfonic acid, polyacrylic acid, and the like. One type of a dopant may be used alone, or two or more types may be used in combination. The dopant may be a polymer of a single monomer or may be a copolymer of two or more types of monomers. Among them, polystyrene sulfonic acid is preferable.

The weight-average molecular weight of the polyanion contained in the first polymer component is not particularly limited. The weight-average molecular weight of the polyanion is 1,000 or more and 200,000 or less, for example. The conductive polymer component containing such a polyanion is likely to be homogeneously dispersed in the first dispersion medium and to attach to the fiber sheet. The weight-average molecular weight of the polyanion may be 1,000 or more and 100,000 or less. Even when a large amount of such a polyanion is contained, an excessive increase in viscosity of the dispersion liquid is suppressed, and the amount of the first polymer component attached to the fiber sheet is likely to increase.

The first polymer component is dispersed in the first dispersion medium in the form of particles, for example. The mode particle diameter of the particles of the first polymer component is not particularly limited and can be appropriately adjusted depending on the polymerization conditions, dispersion conditions, and the like. The mode particle diameter of the particles of the first polymer component is 0.01 μm or more and 0.5 μm or less, for example. When the density of the fiber sheet before compression is less than 0.6 g/cm³ (or 0.55 g/cm³ or less), the mode particle diameter of the particles of the first polymer component contained in the fiber sheet before compression may be 0.02 μm or more and 0.2 μm or less, for example. This makes it easy to attach the particles of the first polymer component to the inside of the fiber sheet. The mode particle diameter herein is the mode value of the particle diameter (mode diameter) in the volume particle size distribution measured by a particle size measurement device using a dynamic light scattering method.

The electrical conductivity of the separator (composite sheet after compression) containing the first polymer component is 0.1 mS/cm or more, for example, and may be 1 mS/cm or more. The higher the electrical conductivity of the separator containing the first polymer component, the greater the effect of reducing the ESR. The electrical conductivity of the separator containing the first polymer component can be adjusted by the types and molecular weights of the conductive polymer and dopant, the amount of the first polymer component attached to the fiber sheet in the first step, the pressing pressure in the second step, and the like. The electrical conductivity of the separator containing the first polymer component is measured by a four-probe method in accordance with JIS K 7194:1994.

### (First Dispersion Medium)

The first dispersion medium includes water. The first dispersion medium may include a non-aqueous solvent. The non-aqueous solvent is a general term for liquids other than water, and includes organic solvents and ionic liquids. The proportion of water in the first dispersion medium may be 50% by mass or more, may be 70% by mass or more, or may be 90% by mass or more. The non-aqueous solvents used together with water may be polar solvents (protic solvents and/or aprotic solvents).

Examples of the protic solvents include alcohols such as methanol, ethanol, propanol, butanol, ethylene glycol (EG), propylene glycol, polyethylene glycol (PEG), diethylene glycol monobutyl ether, glycerin, 1-propanol, butanol, polyglycerin, sorbitol, mannitol, and pentaerythritol, formaldehyde, and the like. Examples of the aprotic solvents include amides such as N-methylacetamide, N,N-dimethylformamide, and N-methyl-2-pyrrolidone, esters such as methyl acetate and γ-butyrolactone (γBL), ketones such as methyl ethyl ketone, ethers such as 1,4-dioxane, sulfur-containing compounds such as dimethyl sulfoxide and sulfolane (SL), and carbonate compounds such as propylene carbonate, and the like.

When the first dispersion medium contains the above-described alcohols (particularly, polyhydric alcohols and sugar alcohols), the electrical conductivity and the impregnation of the separator tend to increase. On the other hand, polyhydric alcohols and sugar alcohols tend to swell the fiber sheet and cause wrinkles. Therefore, the method of manufacturing a separator for an electrolytic capacitor according to the present embodiment has a significant effect of suppressing the occurrence of wrinkles.

### [Separator for Electrolytic Capacitor]

The separator for an electrolytic capacitor according to the embodiment of the present disclosure includes a composite sheet containing a fiber sheet and a conductive polymer component (first polymer component) attached to the fiber sheet. The composite sheet has a density of 0.33 g/cm³ or more and less than 0.74 g/cm³, an air permeability of 0.5 sec/100 mL or more and less than 58 sec/100 mL, and a basis weight of 19.0×10⁻⁴ g/cm² or more. The separator can be obtained by the above-described method of manufacturing a separator for an electrolytic capacitor.

When the density and basis weight of the composite sheet are within the above ranges, the short-circuit resistance of the electrolytic capacitor is improved, the ESR is reduced, and the leakage current is reduced. The density of the composite sheet may be 0.34 g/cm³ or more and 0.53 g/cm³ or less. This reduces the leakage current and easily achieves excellent short-circuit resistance. The basis weight of the composite sheet may be 19×10⁻⁴ g/cm² or more and 35×10⁻⁴ g/cm² or less. The density of the fiber sheet included in the separator may be 0.32 g/cm³ or more and less than 0.72 g/cm³, or may be 0.33 g/cm³ or more and 0.50 g/cm³ or less.

The density and basis weight of the composite sheet can be determined by the method described below.

A test piece of a predetermined size is cut out from the composite sheet, and dried at 125° C. for three hours or more to thoroughly remove any residual first dispersion medium from the test piece. Then, the length, width, thickness, and weight of the test piece are measured, and the weight is divided by the volume, calculated from the length, width, and thickness, to determine the density of the composite sheet. In addition, the weight is divided by the area, calculated from the length and width, to determine the basis weight of the composite sheet. Five test pieces are taken, the densities and basis weights of the five test pieces are determined, and the average values are calculated.

When the air permeability of the composite sheet is within the above range, the first polymer component is sufficiently placed on the outer surface of the fiber sheet and in the inside of the fiber sheet (the gaps between the fibers), so that the ESR is reduced. The air permeability of the composite sheet may be 5 seconds/100 mL or more and 50 seconds/100 mL or less (or 10 seconds/100 mL or less). When the air permeability of the composite sheet is less than 58 seconds/100 mL (or 50 seconds/100 mL or less), the impregnation with the electrolyte solution and the like can be easily ensured.

The air permeability (air permeability resistance) here is an index showing the time (seconds) required for a predetermined volume (100 mL) of air to permeate the separator per unit area when a predetermined pressure difference is applied between both sides of the separator. The air permeability is measured by the Gurley tester method based on JIS P 8117:2009, with the separator test area (permeable portion) being 6.42 cm² and the inner cylinder weight being 567 g. The air permeability is measured after drying the separator at 125° C. for three hours or more and thoroughly removing the residual first dispersion medium from the separator.

The first polymer component is attached to the surfaces of the fibers that constitute the fiber sheet. The first polymer component is placed on the outer surface of the fiber sheet and in the inside of the fiber sheet (the gaps between the fibers).

From the viewpoint of reducing the ESR, the amount of the first polymer component attached may be 0.02 mg/cm² or more, or may be 0.05 mg/cm² or more and 2.0 mg/cm² or less, for example. The amount of the first polymer component attached refers to the mass of the first polymer component attached to the fiber sheet per unit area. The mass of the first polymer component attached to the fiber sheet per unit area does not change before and after the compression of the composite sheet.

The amount of the first polymer component attached can be determined by the method described below.

First, five first samples are prepared by cutting out a predetermined area from the fiber sheet to which the first polymer component is not yet attached, and the average mass of the five first samples is determined. In addition, five second samples are prepared by cutting out the predetermined area from the fiber sheet to which the first polymer component is attached, and the average mass of the five second samples is determined. The difference between the average mass of the five second samples and the average mass of the five first samples is divided by the predetermined area to determine the mass of the first polymer component attached to the fiber sheet per unit area.

The coverage of the separator by the first polymer component may be 60% or more, and is preferably 90% or more. The coverage refers to the area ratio of the first polymer component to the main surface (outer surface) of the separator as viewed from the normal direction of the main surface. The coverage is determined by obtaining an image of the separator as viewed from the normal direction of the main surface using an optical microscope, and binarizing the image. The coverage may also be determined by obtaining an image of the separator as viewed from the normal direction of the main surface using a scanning or transmissive electron microscope, and using the image to perform element mapping of the elements contained in the first polymer component by energy dispersive X-ray spectroscopy (EDX). The coverage may also be determined by obtaining an image of the separator as viewed from the normal direction of the main surface using an optical microscope, and performing Raman mapping using a molecular structure spectrum by Raman spectroscopy.

### [Method of Manufacturing Electrolytic Capacitor]

A method of manufacturing an electrolytic capacitor according to an embodiment of the present disclosure includes a step of preparing an anode foil, a step of preparing a cathode foil, a step of obtaining a separator using the above-described method of manufacturing a separator for an electrolytic capacitor, and a step of laminating the anode foil and the cathode foil with the separator interposed between the anode foil and the cathode foil (hereinafter, also referred to as lamination step).

By the lamination step, a laminated body (hereinafter also referred to as capacitor element) is obtained, including the anode foil, the cathode foil, and the separator interposed between the anode foil and the cathode foil. In this step, the laminated body may be wound. In this case, the end of the cathode foil located in the outermost layer is fixed with a fixing tape.

The anode foil and the cathode foil may be cut to a predetermined size. In this case, the capacitor element may be further subjected to chemical conversion treatment (re-chemical conversion treatment) in order to form a dielectric layer on the end surface (cut surface) of the anode foil.

The step of preparing the anode foil and/or the cathode foil may include a step of attaching the first polymer component to the anode foil and/or the cathode foil. This allows the first polymer component to be contained in a larger amount in the capacitor element. When the first polymer component is attached to the cathode foil and the fiber sheet, a sufficient amount of the conductive polymer component can be retained without impeding the self-repairing performance of the anode foil. When the first polymer component is attached to the anode foil and the fiber sheet, the adhesion between the dielectric layer formed on the surface of the anode foil and the first polymer component is improved, and the ESR is more likely to be reduced. The method for attaching the first polymer component to the electrode foil is not particularly limited, and may be impregnation or coating.

### (Second Polymer Dispersion Liquid Impregnation Step)

The manufacturing method may include a step of impregnating the capacitor element with a second polymer dispersion liquid that contains a second conductive polymer component (hereinafter, also referred to as second polymer component) and a second dispersion medium, and then performing a drying process to remove at least a portion of the second dispersion medium. In this manner, the second polymer component may be contained together with the first polymer component in the capacitor element. It can be expected that the second polymer component will further increase the electrostatic capacitance and will further reduce the ESR. If the first dispersion medium remains in the separator, the second polymer dispersion liquid is guided by the first dispersion medium so that the separator can be easily impregnated with the second polymer dispersion liquid.

The second polymer component can attach to the surfaces of the electrode foil and the separator in the capacitor element. The second polymer component attaches onto the first polymer component contained in the separator. However, since the density of the separator (fiber sheet) is increased by the second step, the particles of the second polymer component are less likely to penetrate into the separator (gaps between the fibers) and are more likely to attach to the outer surface of the separator.

If the electrode foil has a porous part on the surface, the particles of the second polymer component may penetrate into the pits of the porous part. When the first polymer component is attached to the electrode foil, the second polymer component may attach onto the first polymer component.

### (Second Polymer Dispersion Liquid)

The second polymer dispersion liquid contains a second polymer component and a second dispersion medium. The second dispersion medium may include the same compound as that of the first dispersion medium. The second polymer component may contain the same conductive polymer and dopant as those of the first polymer component. The second polymer component may contain a polyanion (hereinafter, referred to as second polyanion) as a dopant.

From the viewpoint of ESR reduction, the weight-average molecular weight of the second polyanion contained in the second polymer component may be larger than the weight-average molecular weight of the first polyanion contained in the first polymer component. From the viewpoint of compatibility with the first polymer component and impregnation with the second polymer dispersion liquid, the weight-average molecular weight of the second polyanion contained in the second polymer component may be smaller than the weight-average molecular weight of the first polyanion contained in the first polymer component. The weight-average molecular weight of the second polyanion may be 1,000 or more and 200,000 or less, or may be 10,000 or more and 150,000 or less, for example.

The content of the second polymer component in the second polymer dispersion liquid may be smaller than the content of the first polymer component in the first polymer dispersion liquid. Specifically, the content of the second polymer component in the second polymer dispersion liquid is preferably 0.5% by mass or more and less than 3% by mass. The viscosity of the second polymer dispersion liquid is preferably lower than the viscosity of the first polymer dispersion liquid. The viscosity of the second polymer dispersion liquid is preferably less than 100 mPa·s.

### (Liquid Component Impregnation Step)

The manufacturing process may include a step of impregnating the capacitor element with a liquid component. If the first dispersion medium remains in the separator, the liquid component is guided by the first dispersion medium and therefore the separator can be easily impregnated with the liquid component.

The liquid component impregnation step may be performed after the formation of the capacitor element. For example, the capacitor element may be stored in a bottomed case, and then the liquid component may be poured into the bottomed case. The liquid component impregnation step may be performed under reduced pressure (for example, an atmosphere with a gauge pressure between −30 kPa and −90 kPa inclusive). If the second polymer dispersion liquid impregnation step is performed, the liquid component impregnation step may be performed after the second polymer dispersion liquid impregnation step. By the liquid component impregnation step, the liquid component is attached to the surfaces of the electrode foil and the separator. The liquid component penetrates into the inside of the separator (gaps between fibers). If the electrode foil has a porous part on the surface, the liquid component penetrates into the pits of the porous part.

The liquid component may include an electrolyte solution that contains a solvent and a solute. The liquid component may include an acid component, or may include an acid component and a base component. The liquid component may include only a solvent (for example, a polyhydric alcohol such as a glycol compound). Containing the liquid component in the capacitor element improves the self-repairing performance of the dielectric layer. Furthermore, containing the electrolyte solution in the capacitor element is advantageous in terms of reducing the ESR and improving the electrostatic capacitance.

### (Electrolyte Solution)

Examples of the solvent contained in the electrolyte solution include sulfone compounds, lactone compounds, carbonate compounds, polyhydric alcohols, and the like. Examples of the sulfone compounds include sulfolane, dimethyl sulfoxide, diethyl sulfoxide, and the like. Examples of the lactone compounds include γ-butyrolactone, γ-valerolactone, and the like. Examples of the carbonate compounds include dimethyl carbonate (DMC), diethyl carbonate (DEC), ethyl methyl carbonate (EMC), ethylene carbonate (EC), propylene carbonate (PC), fluoroethylene carbonate (FEC), and the like. Examples of the polyhydric alcohols include glycol compounds such as ethylene glycol (EG), diethylene glycol, triethylene glycol, propylene glycol, and polyethylene glycol (PEG), glycerin, and the like. These may be used alone or in combination.

In particular, the solvent may contain a compound having two or more hydroxyl groups. Examples of such compounds include polyhydric alcohols. The content of the compound having two or more hydroxyl groups may be 50% by mass or more, may be 60% by mass or more, or may be 70% by mass or more of the total solvent.

The electrolyte solution may contain an acid component. The acid component in the electrolyte solution suppresses dedoping of the dopant from the polymer component and stabilizes the conductivity of the polymer component. Even if the dopant is dedoped from the polymer component, the acid component of the electrolyte solution is re-doped at the site of the dedoped dopant, so that the ESR can be easily kept low.

It is desirable that the acid component in the electrolyte solution generates an anion that is easily dissociated in the electrolyte solution and easily moves in the solvent without excessively increasing the viscosity of the electrolyte solution. Examples of the acid component include aliphatic sulfonic acids having 1 to 30 carbon atoms and aromatic sulfonic acids having 6 to 30 carbon atoms. Among the aliphatic sulfonic acids, monovalent saturated aliphatic sulfonic acids (for example, hexanesulfonic acid) are preferred. Among the aromatic sulfonic acids, aromatic sulfonic acids having a hydroxyl group or a carboxyl group in addition to a sulfo group are preferred. Specifically, oxyaromatic sulfonic acids (for example, phenol-2-sulfonic acid) and sulfoaromatic carboxylic acids (for example, p-sulfobenzoic acid, 3-sulfophthalic acid, and 5-sulfosalicylic acid) are preferred.

Other acid components include carboxylic acids. The carboxylic acids preferably include aromatic carboxylic acids (aromatic dicarboxylic acids) having two or more carboxyl groups. Examples of the aromatic carboxylic acids include phthalic acid (ortho form), isophthalic acid (meta form), terephthalic acid (para form), maleic acid, benzoic acid, salicylic acid, trimellitic acid, and pyromellitic acid. Among them, aromatic dicarboxylic acids such as phthalic acid (ortho form) and maleic acid are more preferable. The carboxyl group of aromatic dicarboxylic acid is stable and is unlikely to promote side reactions. Therefore, the carboxyl group of aromatic dicarboxylic acid exhibits the effect of stabilizing the conductive polymer for a long period of time, which is advantageous for extending the life of the electrolytic capacitor. The carboxylic acid may also be an aliphatic carboxylic acid such as adipic acid.

The acid component may contain a composite compound of an organic acid and an inorganic acid from the viewpoint of thermal stability. Examples of the composite compound of an organic acid and an inorganic acid include borodisalicylic acid, borodioxalic acid, and borodiglycolic acid, which have high heat resistance. The acid component may contain an inorganic acid such as boric acid, phosphoric acid, phosphorous acid, hypophosphorous acid, and phosphonic acid.

In terms of enhancing the effect of suppressing the dedoping phenomenon, the concentration of the acid component may be 5% by mass or more and 50% by mass or less, or may be 15% by mass or more and 35% by mass or less.

The electrolyte solution may contain a base component together with the acid component. At least a portion of the acid component is neutralized by the base component. Therefore, it is possible to suppress the corrosion of the electrode by the acid component while increasing the concentration of the acid component. From the viewpoint of effectively suppressing dedoping, it is preferable that the acid component is in excess of the base component in terms of equivalent ratio. For example, the equivalent ratio of the acid component to the base component may be 1 or more and 30 or less. The concentration of the base component contained in the electrolyte solution may be 0.1 mass % or more and 20 mass % or less, or may be 3 mass % or more and 10 mass % or less.

The base component is not particularly limited. Examples of the base component include ammonia, primary amines, secondary amines, tertiary amines, quaternary ammonium compounds, and amidinium compounds. Examples of each amine include aliphatic amines, aromatic amines, and heterocyclic amines.

The pH of the electrolyte solution is preferably 4 or less, more preferably 3.8 or less, and further preferably 3.6 or less. Setting the pH of the electrolyte solution to 4 or less further suppresses the deterioration of the polymer component. The pH is preferably 2.0 or more.

### (Capacitor Element Sealing Process)

The manufacturing method may include a step of sealing the capacitor element. For example, the capacitor element may be stored in a bottomed case, and then a horizontal drawing process may be performed on the vicinity of the open end of the bottomed case, and the open end may be curled by crimping to a sealing member, and a seat plate may be placed on the curled portion. In this manner, an electrolytic capacitor may be obtained. Then, an aging process may be performed on the electrolytic capacitor while applying a rated voltage. The material of the bottomed case may be a metal such as aluminum, stainless steel, copper, iron, or brass, or an alloy of these metals.

### [Electrolytic Capacitor]

The electrolytic capacitor according to the embodiment of the present disclosure includes an anode foil, a cathode foil, and a separator that is interposed between the anode foil and the cathode foil. That is, the electrolytic capacitor includes a capacitor element. The separator is the above-described separator for an electrolytic capacitor. The capacitor element may be a laminated body of an anode foil, a separator, and a cathode foil, or may be a wound body formed by winding the laminated body. The capacitor element includes a first polymer component as an electrolyte, and may further include a second polymer component and/or an electrolyte solution. The capacitor element may also include a solvent (for example, a polyhydric alcohol such as a glycol compound) instead of the electrolyte solution. The electrolytic capacitor may include one capacitor element, or may include a plurality of capacitor elements.

### (Anode Foil)

The anode foil includes a metal foil that contains a valve metal, and a dielectric layer that covers the surface of the metal foil. Examples of the valve metal include titanium, tantalum, aluminum, niobium, and the like. The metal foil may contain the valve metal in the form of an alloy containing the valve metal or a compound containing the valve metal. The thickness of the anode foil is 15 μm or more and 300 μm or less, for example. The surface of the metal foil is usually roughened by etching or the like. The dielectric layer is formed by providing chemical conversion treatment to the metal foil with the roughened surface, for example. In this case, the dielectric layer may contain an oxide of the valve metal.

### (Cathode Foil)

The cathode foil may be a metal foil containing a valve metal. The thickness of the cathode foil is 15 μm or more and 300 μm or less, for example. The surface of the metal foil may be roughened by etching or the like. A chemical conversion coating film may be formed on the surface of the metal foil by chemical conversion treatment. The cathode foil may be a metal foil having a coating layer on the surface. The coating layer is arranged for the purposes of improving corrosion resistance, reducing the ESR, and the like. The coating layer may contain at least one of carbon and a metal M. In the coating layer, the metal M may be contained as a metal oxide, a metal nitride, or a metal carbide. The metal M includes at least one selected from the group consisting of nickel, titanium, tantalum, and zirconium, for example.

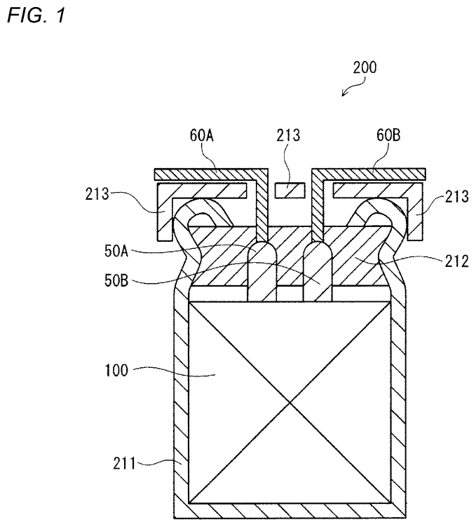

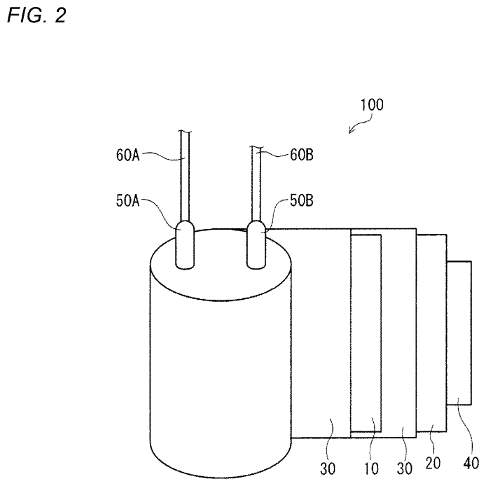

FIG. 1 is a cross-sectional view of an electrolytic capacitor according to an embodiment of the present disclosure. FIG. 2 is a perspective view of a wound body in a partially unwound state.

The electrolytic capacitor 200 includes a wound body 100 as a capacitor element. The wound body 100 is formed by winding an anode foil 10 and a cathode foil 20 with a separator 30 interposed therebetween. The separator 30 is the above-described separator for an electrolytic capacitor. The wound body 100 includes an electrolyte, and the electrolyte is interposed between the anode foil 10 (dielectric layer) and the cathode foil. The electrolyte includes a first polymer component, and may further include a second polymer component and/or an electrolyte solution.

Lead tabs 50A and 50B are connected at one end to the anode foil 10 and the cathode foil 20, respectively. The wound body 100 is formed such that the lead tabs 50A and 50B are wound together with the anode foil 10 and the cathode foil 20. Lead wires 60A and 60B are connected to the other ends of the lead tabs 50A and 50B, respectively.

A fixing tape 40 is arranged on the outer surface of the cathode foil 20 located at the outermost layer of the wound body 100, and the end of the cathode foil 20 is fixed by the fixing tape 40. When the anode foil 10 is prepared by cutting from a large-sized foil, the wound body 100 may further be subjected to chemical conversion treatment in order to provide a dielectric layer on the cut surface.

The electrolytic capacitor 200 includes a sealing member 212 that closes the opening of a bottomed case 211, and a seat plate 213 that covers the sealing member 212. The wound body 100 is stored in the bottomed case 211 such that the lead wires 60A and 60B are located on the opening side of the bottomed case 211. The lead wires 60A and 60B are led out from the sealing member 212 and penetrate the seat plate 213. The material of the bottomed case 211 can be a metal such as aluminum, stainless steel, copper, iron, brass, or an alloy of these metals.

The sealing member 212 is placed at the opening of the bottomed case 211 in which the wound body 100 is stored, the open end of the bottomed case 211 is curled by being crimped to the sealing member 212, and the seat plate 213 is placed on the curled portion, thereby sealing the wound body 100 in the bottomed case 211. The sealing member 212 may be made of any insulating material, and is preferably an elastic body. The material of the sealing member 212 is preferably excellent in heat resistance, such as silicone rubber or fluororubber.

### EXAMPLES

The present invention will be described in more detail below based on examples, but the present invention is not limited to these examples.

### Examples 1 to 7 and Comparative Examples 6 and 7

Electrolytic capacitors with a rated voltage of 35 V were fabricated by the following procedure.

### (Preparation of Fiber Sheet)

A fiber sheet (thickness: 60 μm) was prepared, the density of which is shown in Table 1. For the fiber sheet, a nonwoven fabric containing cellulose fibers was used.

### (Preparation of First Polymer Dispersion Liquid)

A mixed solution was prepared by dissolving 3,4-ethylenedioxythiophene and polystyrene sulfonic acid (PSS, weight-average molecular weight 100,000) in ion-exchanged water. Iron (III) sulfate (oxidant) was added to the mixed solution while stirring the mixed solution to carry out a polymerization reaction. Then, the reaction solution was dialyzed to remove unreacted monomers and the oxidant, thereby obtaining a first polymer dispersion liquid that contained polyethylenedioxythiophene doped with PSS (dopant) (PEDOT/PSS, first polymer component). The concentration of the first polymer component in the first polymer dispersion liquid was 2% by mass. The viscosity of the first polymer dispersion liquid was 40 mPa·s.

### (Step of Applying First Polymer Dispersion Liquid to Fiber Sheet: First Step)

The first polymer dispersion liquid was applied to both sides of the fiber sheet using a gravure coater. Then, a drying process was performed to obtain a composite sheet (thickness T0: 60 μm) in which the first polymer component was attached to the fiber sheet. The mass of the first polymer component attached per unit area of the fiber sheet was 0.3 mg/cm². The area coverage of one main surface of the fiber sheet by the first polymer component was 98%. The drying process was performed at atmospheric pressure at 105° C. for hours.

### (Step of Compressing Composite Sheet: Second Step)

The composite sheet was roll-pressed to obtain a separator. At this time, the pressing pressure was adjusted to set the thickness T1 of the composite sheet (separator) after pressing to the value shown in Table 1. The density, basis weight, and air permeability of the separator determined by the above-described methods reached the values shown in Table 1. The electrical conductivity of the separator (composite sheet after pressing) was 1.0 mS/cm. In this manner, separators a1 to a7 and b6 and b7 of Examples 1 to 7 and Comparative Examples 6 and 7 were obtained.

TABLE 1

| | First step | | | | | | Second step | | | | | |
|---|---|---|---|---|---|---|---|---|---|---|---|---|
| | | | Pre-compression composite sheet | | | | | Post-compression composite sheet | | | | |
| | Pre-compression | | | | | Air | Post- | | | | Air | |
| | fiber sheet | | | Thick- | | perme- | compression | | Thick- | | perme- | Thick- |
| | Thick- | | | ness | Basis | ability | fiber sheet | | ness | Basis | ability | ness |
| | ness | Density | Density | T0 | weight | (second/ | Density | Density | T1 | weight | (second/ | ratio |
| | (μm) | (g/cm³) | (g/cm³) | (μm) | (g/cm²) | 100 mL) | (g/cm³) | (g/cm³) | (μm) | (g/cm²) | 100 mL) | T1/T0 |
| Example 1 | 60 | 0.30 | 0.32 | 60 | 19.2 × 10⁻⁴ | 5 | 0.67 | 0.71 | 27 | 19.2 × 10⁻⁴ | 7 | 0.45 |
| Example 2 | 60 | 0.30 | 0.32 | 60 | 19.2 × 10⁻⁴ | 5 | 0.60 | 0.64 | 30 | 19.2 × 10⁻⁴ | 6 | 0.50 |
| Example 3 | 60 | 0.30 | 0.32 | 60 | 19.2 × 10⁻⁴ | 5 | 0.50 | 0.53 | 36 | 19.2 × 10⁻⁴ | 6 | 0.60 |
| Example 4 | 60 | 0.30 | 0.32 | 60 | 19.2 × 10⁻⁴ | 5 | 0.40 | 0.43 | 45 | 19.2 × 10⁻⁴ | 6 | 0.75 |
| Example 5 | 60 | 0.30 | 0.32 | 60 | 19.2 × 10⁻⁴ | 5 | 0.33 | 0.34 | 56 | 19.2 × 10⁻⁴ | 5 | 0.93 |
| Example 6 | 60 | 0.30 | 0.32 | 60 | 19.2 × 10⁻⁴ | 5 | 0.32 | 0.33 | 58 | 19.2 × 10⁻⁴ | 5 | 0.97 |
| Example 7 | 60 | 0.50 | 0.52 | 60 | 31.2 × 10⁻⁴ | 18 | 0.60 | 0.62 | 50 | 31.2 × 10⁻⁴ | 38 | 0.83 |
| Comparative | 60 | 0.60 | 0.62 | 60 | 37.2 × 10⁻⁴ | 36 | 0.72 | 0.74 | 50 | 37.2 × 10⁻⁴ | 58 | 0.83 |
| example 6 | | | | | | | | | | | | |
| Comparative | 60 | 0.88 | 0.90 | 60 | 54.0 × 10⁻⁴ | 117 | 0.96 | 0.98 | 55 | 54.0 × 10⁻⁴ | 115 | 0.92 |
| example 7 | | | | | | | | | | | | |
| Comparative | 60 | 0.30 | 0.32 | 60 | 19.2 × 10⁻⁴ | 5 | — | — | — | — | — | — |
| example 1 | | | | | | | | | | | | |
| Comparative | 50 | 0.88 | 0.90 | 50 | 45.0 × 10⁻⁴ | 71 | — | — | — | — | — | — |
| example 2 | | | | | | | | | | | | |
| Comparative | 30 | 0.60 | 0.62 | 30 | 18.6 × 10⁻⁴ | 5 | — | — | — | — | — | — |
| example 3 | | | | | | | | | | | | |
| Comparative | 45 | 0.40 | 0.42 | 45 | 18.9 × 10⁻⁴ | 5 | — | — | — | — | — | — |
| example 4 | | | | | | | | | | | | |
| Comparative | 60 | 0.88 | 0.90 | 60 | 54.0 × 10⁻⁴ | 117 | — | — | — | — | — | — |
| example 5 | | | | | | | | | | | | |

### (Fabrication of Capacitor Element)

An anode lead tab and a cathode lead tab were connected to the anode foil and the cathode foil, and the anode foil and the cathode foil were wound with a separator interposed therebetween while the lead tabs were also wound together. The anode foil was an etched foil that had a dielectric layer on its surface and was cut to a predetermined size. The etched foil was obtained by etching an aluminum foil (thickness 100 μm). The dielectric layer was formed by applying chemical conversion treatment to the surface of the etched foil. The cathode foil was an etched foil obtained by etching an aluminum foil (thickness 50 μm) and cutting to a predetermined size.

An anode lead wire and a cathode lead wire were connected to the ends of the lead tabs protruding from the wound body. The obtained wound body was again subjected to chemical conversion to form a dielectric layer on the end surface of the anode foil. The end of the outer surface of the wound body was fixed with a fixing tape. In this manner, a capacitor element was obtained.

(Impregnation with Electrolyte Solution)

After the capacitor element was stored in a bottomed case, an electrolyte solution was injected into the capacitor element in the bottomed case at room temperature under atmospheric pressure. In this manner, the capacitor element was impregnated with the electrolyte solution. The electrolyte solution was a solution of triethylamine phthalate dissolved in a solvent mainly containing ethylene glycol.

### (Sealing of Capacitor Element)

A sealing member and a seat plate were arranged in the opening of the bottomed case to seal the capacitor element. In this manner, an electrolytic capacitor was completed. After that, the electrolytic capacitor was subjected to aging treatment at 105° C. for two hours with application of a rated voltage. In this manner, electrolytic capacitors A1 to A7 and B6 and B7 of Examples 1 to 7 and Comparative Examples 6 and 7 were obtained.

### Comparative Example 1

The composite sheet obtained in the first step was used as a separator b1 without performing the second step (composite sheet compression step). An electrolytic capacitor B1 of Comparative Example 1 was obtained in the same manner as in Example 1, except that the separator b1 was used instead of the separator a1.

The density, basis weight, and air permeability of the separator b1 took the values shown in Table 1. The mass of the first polymer component per unit area of the fiber sheet was 0.3 mg/cm². The area coverage of one main surface of the fiber sheet by the first polymer component was 98%.

### Comparative Examples 2 to 5

The first step was performed in the same manner as in Example 1, except that fiber sheets having the thicknesses and densities shown in Table 1 were prepared, and the second step (composite sheet compression step) was not performed. The composite sheets obtained in the first step were used as separators b2 to b5. Electrolytic capacitors B2 to B5 of Comparative Examples 2 to 5 were obtained in the same manner as in Example 1, except that the separators b2 to b5 were used instead of the separator a1.

The densities, basis weights, and air permeabilities of the separators b2 to b5 took the values shown in Table 1. The mass of the first polymer component per unit area of each fiber sheet was 0.3 mg/cm². The area coverage of one main surface of each fiber sheet by the first polymer component was 98%.

### [Evaluation]

Each electrolytic capacitor was evaluated as described below.

### (ESR Measurement)

The ESR (Ω) of each electrolytic capacitor was measured at a frequency of 100 kHz in an environment of 20° C. The number of measured capacitors was 100, and their average value was calculated.

### (Evaluation of Short-Circuit Resistance)

A rated voltage was applied to each electrolytic capacitor in an environment of 20° C., and the current value after 120 seconds was measured. If the current value was 1.0 mA or more, the capacitor was determined as being short-circuited. The number of measured capacitors was 100, and the ratio of the number of short-circuited capacitors to the number of measured capacitors was calculated as short-circuit occurrence rate (%).

Table 2 shows the evaluation results. In Table 2, A1 to A7 and B6 and B7 are electrolytic capacitors including the separators a1 to a7 and b6 and b7, respectively. Also, in Table 2, B1 to B5 are electrolytic capacitors including the separators b1 to b5, respectively.

TABLE 2

| | | | Short-circuit |
|---|---|---|---|
| Electrolytic | | ESR | occurrence |
| capacitor | Separator | (Ω) | rate (%) |
| A1 | a1 | 7.1 | 2 |
| A2 | a2 | 7.3 | 1 |
| A3 | a3 | 7.4 | 0 |
| A4 | a4 | 7.7 | 0 |
| A5 | a5 | 8.1 | 0 |
| A6 | a6 | 8.5 | 3 |
| A7 | a7 | 10.9 | 1 |
| B6 | b6 | 15.1 | 0 |
| B7 | b7 | 19.2 | 0 |
| B1 | b1 | 10.1 | 12 |
| B2 | b2 | 31.8 | 0 |
| B3 | b3 | 13.3 | 2 |
| B4 | b4 | 14.3 | 1 |
| B5 | b5 | 38.7 | 0 |

In the electrolytic capacitors A1 to A7, good short-circuit resistance was obtained along with low ESR. Among them, the electrolytic capacitors A2 to A5 (especially A3 to A5) achieved excellent short-circuit resistance along with low ESR.

In the electrolytic capacitor B1, the density of the composite sheet (fiber sheet) was low, and short-circuit resistance was reduced. In the electrolytic capacitors B2 and B5 to B7, the amount of polymer component attached to the inside of the high-density fiber sheet was small, and the ESR was increased. The separators b3 and b4 obtained in Comparative Examples 3 and 4 had the same fiber sheet density and thickness as those of the separators a2 and a4 obtained in Examples 2 and 4, respectively, but had smaller density and basis weight than those of the separators a2 and a4, and had small amounts of polymer component attached to the inside of the fiber sheet. Therefore, the ESRs of the electrolytic capacitors B3 and B4 were increased compared to those of the electrolytic capacitors A2 and A4.

### INDUSTRIAL APPLICABILITY

The separator for an electrolytic capacitor according to the present disclosure is suitably used in electrolytic capacitors that are required to have excellent short-circuit resistance and low ESR.

Although the present invention has been described with respect to the presently preferred embodiments, such disclosure should not be interpreted as limiting. Various variations and modifications will no doubt become apparent to those skilled in the art to which the present invention pertains upon reading the above disclosure. Therefore, the appended claims should be interpreted to cover all variations and modifications without departing from the true spirit and scope of the present invention.

### REFERENCE SIGNS LIST

10: anode foil, 20: cathode foil, 30: separator, 40: fixing tape, 50A, 50B: lead tab, 60A, 60B: lead wire, 100: wound body, 200: electrolytic capacitor, 211: bottomed case, 212: sealing member, 213: seat plate

1. A method of manufacturing a separator for an electrolytic capacitor, the method comprising:
a first step of attaching a conductive polymer component to a fiber sheet to obtain a composite sheet; and
a second step of compressing the composite sheet to obtain a separator,
wherein a density of the composite sheet before compression is less than 0.60 g/cm³.

2. The method of manufacturing a separator for an electrolytic capacitor according to claim 1,
wherein the first step includes:
a step of preparing a conductive polymer dispersion liquid that contains the conductive polymer component and a dispersion medium; and
a step of applying the conductive polymer dispersion liquid to the fiber sheet or impregnating the fiber sheet with the conductive polymer dispersion liquid, and then removing at least a portion of the dispersion medium.

3. The method of manufacturing a separator for an electrolytic capacitor according to claim 1, wherein a density of the fiber sheet before compression is 0.58 g/cm³ or less.

4. The method of manufacturing a separator for an electrolytic capacitor according to claim 1, wherein in the second step, the composite sheet is roll-pressed.

5. The method of manufacturing a separator for an electrolytic capacitor according to claim 1, wherein a ratio T1/T0 of a thickness T1 of the composite sheet after compression to a thickness T0 of the composite sheet before compression is 0.50 or more and 0.95 or less.

6. The method of manufacturing a separator for an electrolytic capacitor according to claim 1, wherein the fiber sheet contains at least a cellulose fiber.

7. The method of manufacturing a separator for an electrolytic capacitor according to claim 6, wherein the fiber sheet contains the cellulose fiber and a synthetic fiber.

8. A method of manufacturing an electrolytic capacitor, the method comprising:
a step of preparing an anode foil;
a step of preparing a cathode foil;
a step of obtaining a separator by the method of manufacturing a separator for an electrolytic capacitor according to claim 1; and
a step of laminating the anode foil and the cathode foil with the separator interposed between the anode foil and the cathode foil.

9. A separator for an electrolytic capacitor, comprising a composite sheet that includes a fiber sheet and a conductive polymer component attached to the fiber sheet,
wherein the composite sheet has a density of 0.33 g/cm³ or more and less than 0.74 g/cm³, an air permeability of 0.5 sec/100 mL or more and less than 58 sec/100 mL, and a basis weight of 19.0×10⁻⁴ g/cm² or more.

10. The separator for an electrolytic capacitor according to claim 9, wherein the composite sheet has a thickness T1 of 20 μm or more and 90 μm or less.

11. An electrolytic capacitor comprising:
an anode foil;
a cathode foil; and
a separator interposed between the anode foil and the cathode foil,
wherein the separator is the separator for an electrolytic capacitor according to claim 9.
